(19) United States
(12) Patent Application Publication
(10) Pub. No.: US 2016/0324192 A1
(43) Pub. Date: Nov. 10, 2016

(54) CABLE DRIVE MANUAL POPCORN POPPER

(71) Applicant: Victorio, LLC, Orem, UT (US)

(72) Inventor: Nicholas J. Palmer, Orem, UT (US)

(21) Appl. No.: 15/146,285

(22) Filed: May 4, 2016

Related U.S. Application Data
(60) Provisional application No. 62/156,890, filed on May 4, 2015.

(51) Int. Cl. A47J 36/06; A47J 36/16

(52) U.S. Cl. CPC A23L 1/1815; A47J 36/165; A47J 36/06; A23V 2002/00

(57) ABSTRACT

Manual popcorn poppers with integrated stirrers and methods of making and using such poppers are disclosed. Some embodiments of an exemplary popcorn popper may include a pot or pan and a lid. The lid may include an integral stirrer to stir popcorn in the pan when being popped to avoid burning. The stirrer may be rotated with a rotating crank at the end of a handle for holding and moving the popcorn popper. By rotating the crank, a cable may rotate within a chaseway formed within the lid and handle which then transfers the rotating motion of the crank to the stirrer. The stirring cable may be used to change the plane of the rotating force or moment applied to the crank, such that a cranking motion about one axis may produce a stirring action about another axis approximately 90 degrees from the cranking axis without the use of gears and rods.

### RELATED APPLICATIONS

This application claims priority to U.S. Provisional Application No. 62/156,890 filed May 4, 2015, entitled Cable Drive Manual Popcorn Popper.

### BACKGROUND

1. Field of the Invention

This application relates generally to popcorn poppers. More specifically, this application relates to a manual popcorn popper with an integrated stirrer that is driven by a cable.

2. Background of the Invention and Related Art

Popcorn has been around for many, many years. Popcorn is a natural, low calorie, low fat snack that has stood the test of time. For most of that time, people have popped popcorn by holding a covered pan or popcorn popper over a fire or other heat source while rapidly moving the popcorn popper to avoid burning the popcorn. Manual popcorn popping can be fun, particularly for kids, but usually requires more skill than a child has to keep from burning the popcorn, or successfully popping enough kernels.

Subsequently, popcorn poppers with built-in stirrers were introduced, almost always using gears and rods to rotate a stirrer in the bottom of the popper, which made stove-top or campfire popping easier. However, several problems were noted with these designs. For example, in many, the gears and rods and other drive mechanisms tended to bind and fail, reducing the enjoyment of this type of popcorn popper. In others, the actuator to cause the stirring was hard to use, requiring a considerable amount of forearm strength and stamina, while others included cranks located on top of the popper, which were unsafe due to the potential for burns when using the cranks. What is needed is a reliable hand operated popcorn popper that overcomes the common reliability and usefulness problems of current hand operated popcorn poppers.

### SUMMARY AND OBJECTS OF THE INVENTION

Exemplary manual popcorn poppers with integrated stirrers and methods of making and using such poppers are disclosed. Some embodiments of an exemplary popcorn popper may include a pan and a lid. The lid may include an integral stirrer to stir popcorn in the pan when being popped to avoid burning. The stirrer may be rotated with a rotating crank at the end of a handle for holding and moving the popcorn popper. By rotating the crank, a cable may rotate within a chaseway formed within the lid and handle which then transfers the rotating motion of the crank to the stirrer. The stirring cable may be used to change the plane of the rotating force or moment applied to the crank, such that a cranking motion about one axis may produce a stirring action about another axis approximately 90 degrees from the cranking axis without the use of gears and rods.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 is a perspective view of a representative popcorn popper having a hand crank and a stirring mechanism in a lid and a pot;

FIG. 2 is a perspective view of a representative popcorn popper having a hand crank and a stirrer, with direction arrows showing the related movements of the crank and stirrer;

FIG. 3 is a perspective view of a representative popcorn popper having a hand crank and a closed lid;

FIG. 4 is a perspective view of a partial assembly of a lid with integrated stirrer for use with a representative popcorn popper;

FIG. 5 is a top view of the popcorn popper of FIG. 2;

FIG. 6 is a cross sectional view of the popcorn popper of FIG. 4 along the A-A sectional line;

FIG. 7 is a side view a representative popcorn popper having a hand crank and an open lid; and

FIG. 8 is another side view a representative popcorn popper having a hand crank and an open lid.

Together with the following description, the Figures demonstrate and explain the principles of manual popcorn poppers with cable drive stirrers and methods for making and using the same. In the Figures, the thickness and configuration of components may be exaggerated for clarity. The same reference numerals in different Figures represent the same component.

### DETAILED DESCRIPTION OF THE PREFERRED EMBODIMENTS

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry. For example, while the description below focuses on a popcorn popper with a horizontal crank at the end of a short handle, other types of cranks, handle lengths, and planes of cranks in various configurations that might use a cable drive.

In addition, as the terms on, disposed on, attached to, connected to, or coupled to, etc. are used herein, one object (e.g., a material, element, structure, member, etc.) can be on, disposed on, attached to, connected to, or coupled to another object—regardless of whether the one object is directly on, attached, connected, or coupled to the other object or whether there are one or more intervening objects between the one object and the other object. Also, directions (e.g., on top of, below, above, top, bottom, side, up, down, under, over, upper, lower, lateral, orbital, horizontal, etc.), if provided, are relative and provided solely by way of example and for ease of illustration and discussion and not by way of limitation. Where reference is made to a list of elements (e.g., elements a, b, c), such reference is intended to include any one of the listed elements by itself, any combination of less than all of the listed elements, and/or a combination of all of the listed elements. Furthermore, as used herein, the terms a, an, and one may each be interchangeable with the terms at least one and one or more.

The Figures show exemplary embodiments of popcorn poppers with cable drive stirring mechanisms. As shown pot and a removable lid with an integrated handle and stirrer comprise the popcorn cooker. When cooking popcorn manually on a fire or stove, it is important to have a closed popping/cooking chamber to keep kernels in and to contain the popped popcorn so it can be used. This presents a problem since popped popcorn can easily burn once popped.

One solution has been to vigorously move the popper while on the heat source to keep the popped corn from burning and encouraging the denser unpopped kernels to stay on the bottom of the popper to get hot enough to pop. This method requires considerable strength and skill Other popper designs included integrated stirrers, but all prior designs had reliability and dangerous design problems, making them frustrating and difficult to use.

In the Figures, an exemplary popper design provides a cable drive to transfer the rotating force of the crank handle to the stirrer near the bottom of the pan. When the crank is rotated, the stirrer continuously moves to keep popped corn from settling on the bottom of the pan to avoid burning while also allowing kernels to stay on the heated bottom of the pan. The ingenious use of the cable drive mechanism provides a transfer of the rotational force from the crank axis to the non-parallel stirrer axis without the need for gears or solid rods, which tend to wear and bind in other poppers. Such a design provides ease of manufacture while also reducing the failures of previous designs.

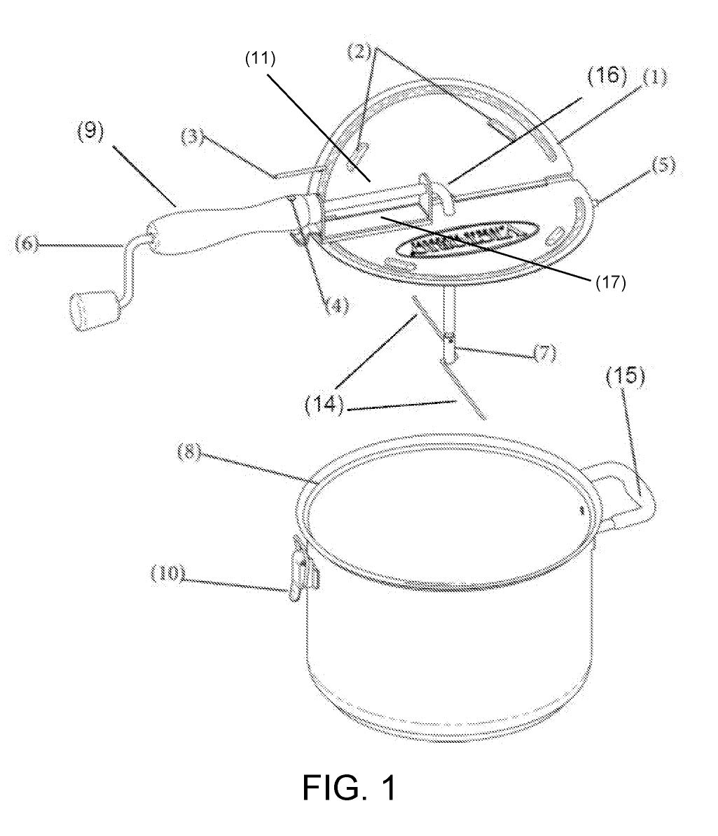

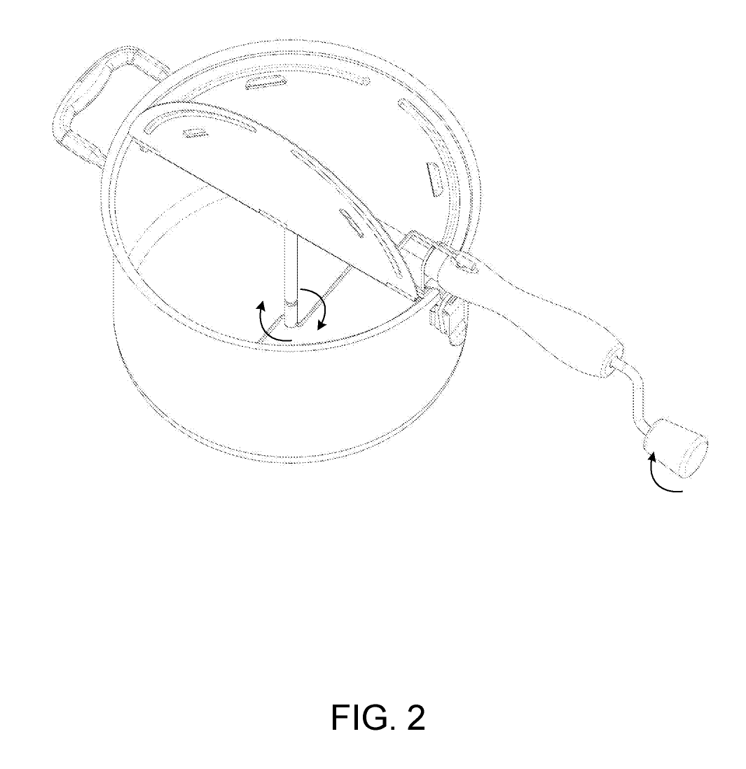

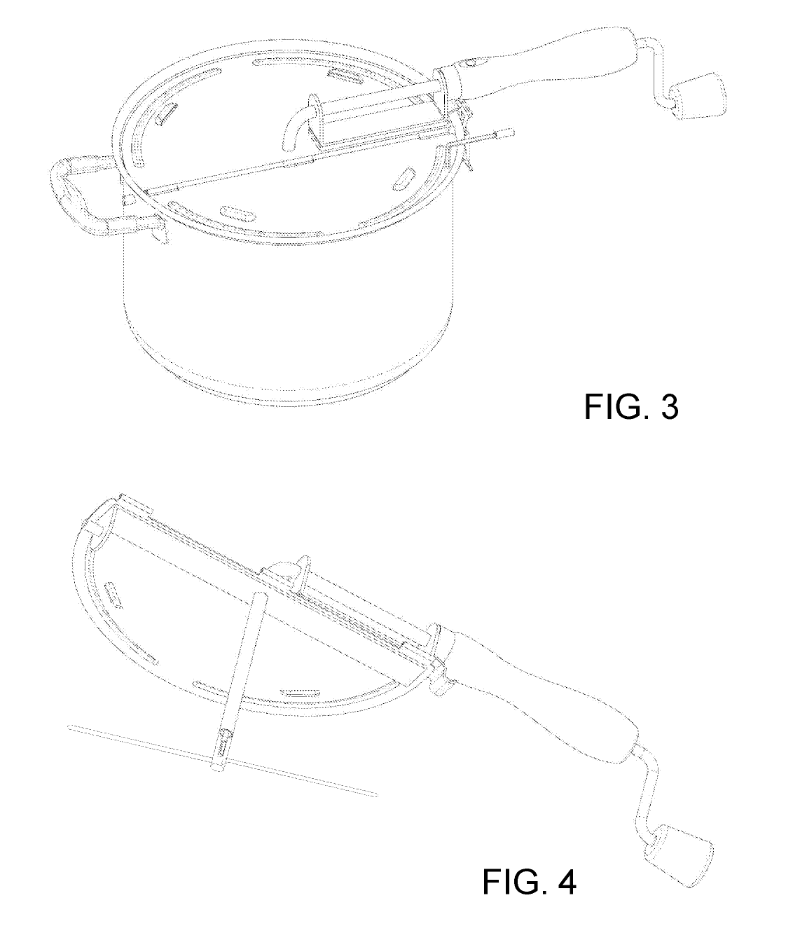

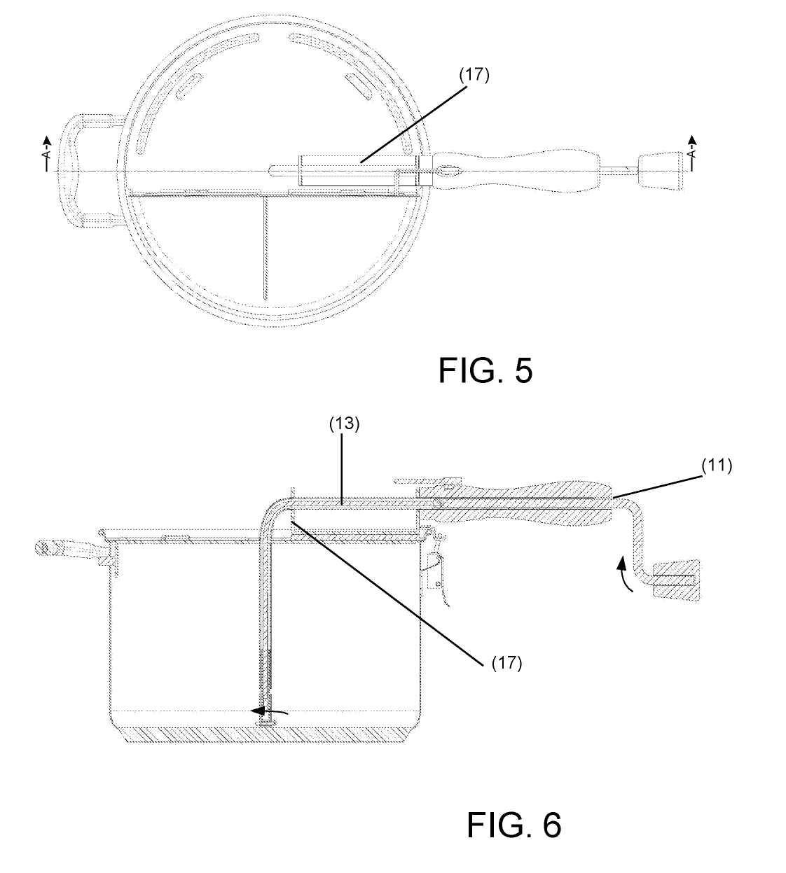

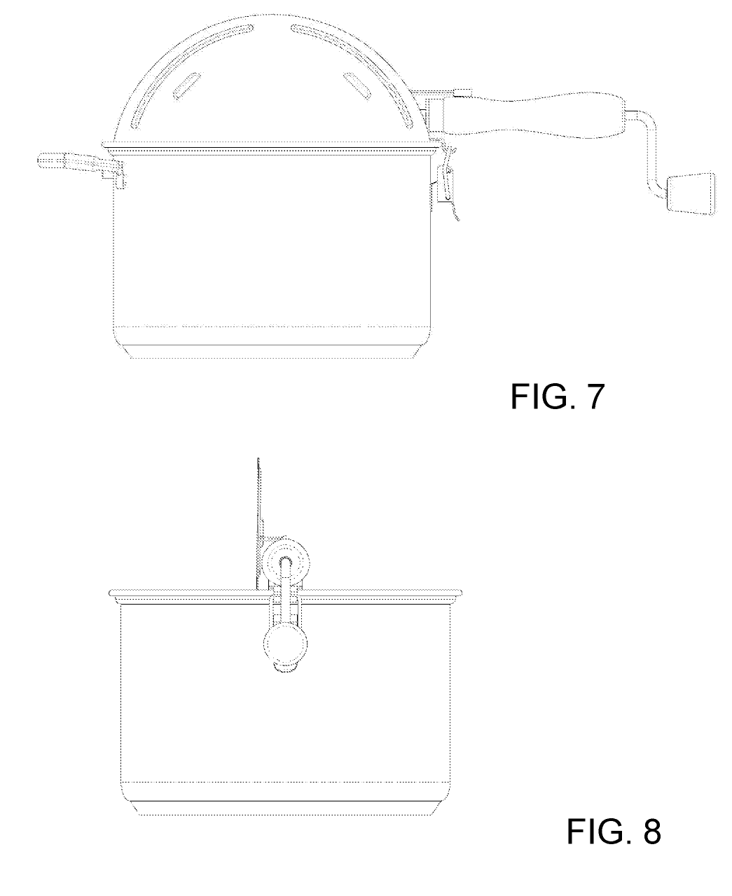

Referring now to FIGS. 1-7, a first embodiment of a stove-top popcorn popper may comprise a lid 1 divided bilaterally to form a butterfly lid with steam vents 2 on each half thereon to allow steam and pressure to escape during cooking. The lid 1 comprises a butterfly lid with two halves divided by a seam and is selectively manipulable. In some embodiments each lid half can be lifted independent of the other lid half. In alternative embodiments only one lid can be lifted and the other lid is selectively secured to the pot 8. The half of the lid which can be lifted is connected to the other half by a hinge. The non-hinged half of the lid and the handle 9 are fixed so as to prevent the lid from changing its planar relationship relative to the handle. This allows the rigid tube 16, discussed below, to pass through the lid. The lid is selectively attached to pot 8 of the popcorn popper and can be electively removed for cleaning the lid, the stirring mechanism 11 and its parts, the pot 8, or to fully access the popcorn popper.

The actuatable half of the lid 1 may further comprise a metal lifting rod 3 to allow the user to lift the lid 1 without exposing the user's skin to hot steam or oil when the popcorn is finished cooking. Manipulating the lid 1 will allow the user to access the popcorn popper and pour in ingredients such as popcorn kernels, oil or salt, or alternatively to remove popped popcorn from the popcorn popper. A magnet 4 is provided in the handle 9 to selectively secure the lid by its lifting rod 3 in a fixed position while the popcorn popper is repositioned, such as when pouring out contents. The lifting rod 3 may comprise ferrous material to attract the magnet 4. However, alternative embodiments comprise securing the lid in an open position using alternative means such as a mechanical latch. When selectively attaching the lid 1 to the pot 8, a lid pin is provided. The lid pin 5 is inserted into an aperture in the side of the pot 8 to secure the lid to the pot 8. The lid 1 is further selectively secured by a lid latch 10. The lid 1 further comprises a handle 9 with a chaseway 12 which can lift the lid, or when the lid is secured to the pot the handle can lift the lid and pot.

Alternative embodiments of the popcorn popper further comprise a stirring mechanism 11. The stirring mechanism 11 may comprise a crank handle 6, a gearless flex-drive drive 7 and stirring arms 14. The stirring mechanism 11 agitates or stirs kernels to prevent burning while they are being heated and popped. The handle's chaseway 12 is a hollow channel through the length of the pot handle 9 which houses the end of the crank handle 6, a cable. The stirring mechanism 11 further comprises crank handle 6 which is inserted into the end of the chaseway 12 but not so as to fix the crank handle 6 to the handle 9. The end of the crank handle 6 which is inserted into the chaseway 12 is connected to the gearless flex-drive 7 which comprises a length of cable 13 which runs through the chase way, through a channel or tube 16 extending from the end of the handle 9. The tube 16 is a single piece of material which bends around a ninety degree angle, passes through the lid 1 and into the pot 8. The cable of the gearless flex-drive 7 terminates at a length approximately equal to the depth of the pot 8 so as to position the end of the stirring mechanism at the bottom of the pot 8 when the lid 1 is secured to the pot 8. Stirring arms 14 are coupled to the distal end of the cable from the handle 9 and extend away from the end of the cable so the stirring arms lie in the same plane as the bottom of the pot 8. The stirring arms may be rigid, flexible or hinged to allow the arms 14 to actuate over popcorn seeds. The stirring arms 14 may also comprise angled blades that lift kernels off the bottom of the pot, or which lift popped kernels off the bottom of the pot and allow un-popped kernels to remain in contact with the heat on the bottom of the pot. In addition, in alternative embodiments the arms 14 may further comprise a flexible edge on the surface closest to the pot's bottom which scrapes the bottom of the pot 8 while the arms are being turned. The gearless flex-drive 7 comprises a single piece of cable 13 which is flexible enough to make the ninety degree turn, but is also rigid so as to minimize twisting in the tube as the hand crank handle 9 is turned. A user turning the crank handle 6 directly turns the cable, which runs through the tube 16 and terminates proximate the pot's bottom. The stirring arms extend from the end of the cable, thus when the cable is turned the stirring arms also turn. Thus the stirring mechanism 11 allows the user to turn the stirring arms using the hand crank without the need for gears or other mechanical means. The pot 8 further comprises a pouring handle 15 which is supports positioning the pot 8 while being manipulated. The

In some embodiments, the handle may be long to accommodate a campfire design to keep hands remote from the fire with still adequately stirring the popcorn while popping.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

What is claimed:

1. A popcorn popper comprising:
a stirring mechanism comprising a hand crank, a flex drive coupled to the hand crank, and stirring arms, the flex-drive further comprising a cable and tube wherein the cable is fixed to the hand crank so that each revolution in the hand crank results in the same revolution in the cable and stirring arms.

2. The popcorn popper of claim 1 further comprising:
a lid comprising a handle further comprising a chaseway wherein hand crank is positioned on the distal end of the handle, the cable passes through the chaseway, and the tube extends from the proximal end of the chaseway and through the lid.

3. The popcorn popper of claim 1 further comprising:
the lid of claim 2 further comprising two halves, a first half which is hinged, and a second half which is fixed to the handle to prevent the lid from changing its planar relationship to the handle.

4. The popcorn popper of claim 1 further comprising:
a pot having an open top and a bottom configured to be heated with a heat source.

5. The popcorn popper of claim 4 further comprising:
at least one stirring arm wherein the stirring arm comprises a blade which is positioned proximate the bottom of the pot and turns as the stirring mechanism is actuated.

6. A method of popping popcorn using a stirring arm using a cable drive comprising;
providing a stirring mechanism comprising a crank handle, a cable with a first arm fixed to the crank handle, and stirring arms fixed to the second end of the cable;
placing the stirring mechanism into a heated pot with popcorn kernels inside; and
turning the crank handle to actuate the stirring arms while the popcorn kernels are heated until they pop to make popcorn.

7. The method of claim 6 further comprising:
providing a lid comprising a handle with a chaseway in the handle and a tube extending from the end of the chaseway, bending so as to pass through the top of the lid and exit the bottom of the lid;
placing crank handle on a first end of the chaseway; and
placing the cable through the chaseway and tube.
